(19) United States
(12) Patent Application Publication
(10) Pub. No.: US 2005/0063599 A1
(43) Pub. Date: Mar. 24, 2005

(54) Image compressing apparatus and image compressing method

(76) Inventor: Yutaka Sato, Osaka (JP)

Correspondence Address: COOPER & DUNHAM, LLP, 1185 AVENUE OF THE AMERICAS, NEW YORK, NY, 10036, US

(21) Appl. No.: 10/913,775

(22) Filed: Aug. 6, 2004

(30) Foreign Application Priority Data
Aug. 20, 2003 (JP) 2003-296093

(51) Int. Cl. G06K 9/36

(52) U.S. Cl. 382/232

(57) ABSTRACT

From given code data, a first total data amount of codes is calculated for each processing unit. A second total data amount of codes is calculated for each processing unit from the first data amount of codes for each processing unit, which second data amount is a data amount obtained when image data obtained from decoding the code data is again compressed and coded at a higher compression rate. A re-compressed code data is obtained from updating the additional information to information for the re-compressed state, and reading the data of codes for each processing unit from a memory for the second total data amount in a predetermined manner.

### BACKGROUND OF THE INVENTION

1. Field of the Invention

The present invention relates to an image compressing apparatus which performs compressing and coding of image data after performing frequency analysis and, in particular, to an image compressing apparatus performing compressing and coding of image data according to JPEG2000 for example, and an image compressing method therefor.

2. Description of the Related Art

JPEG2000 is known as a coding method suitable for handling a high definition image. In coding processing according to JPEG2000, given image data is converted into data of respective color components of Y, Cb and Cr in color conversion processing. After that, two-dimensional discrete wavelet transform (DWT), which is a first method of frequency analysis, is performed on the data of each color component. For example, two-dimensional discrete wavelet transform in a level 2 is applied, and thus, wavelet coefficients in respective subbands, i.e., 3LL, 3HL, 3LH, 3HH, 2HL, 2LH, 2HH, 1HL, 1LH and 2HH are obtained. Then, after performing scalar quantization on wavelet coefficients of each subband, entropy coding processing is performed. In this processing, the wavelet coefficients of each subband are then handled in each code block unit which is a smaller pixel matrix, and the wavelet coefficients in each code block is divided into bit planes. Then, for each code block, in an order starting from the top bit plane, scanning (so-called coefficient modeling processing) is performed in three types of methods. After that, MQ coding processing is performed. The above-mentioned three types of scanning methods includes so-called “cleanup pass”, “significant propagation pass” and “magnitude refinement path”, respectively.

Compression processing of code data is then carried out in such as manner that, for example, from among the data of MQ codes obtained from the above-mentioned entropy coding processing, data is discarded (truncated) in an order starting from data of coding passes for the least significant bit plane toward the most significant bit plane for all the code blocks for each subband. To discard data means to replace the value of bit data with zero (null data).

Then, as code creation processing, a bit stream of the MQ codes obtained from the above-mentioned compressing processing is added to a header which is made of code information concerning the MQ codes obtained from the compression processing, and thus, code data is created. As for the coding processing according to JPEG2000, detailed description is found in ‘Summary of New International Standard Method for Static Image Coding (JPEG2000)’, Video Information Media Society Journal, 2000, Vol. 54, No. 2, pp. 164-171.

### SUMMARY OF THE INVENTION

In order to further generate code data compressed at a different compression rate with the use of the above-mentioned once compressed code data, it is conventionally necessary to decode the wavelet coefficients in each subband of the code data, then again perform entropy coding, and creating code data compressed at the different compression rate again. However, in this case, a large amount of operation for a long time may be required, and also, a large size of processing circuit may be required accordingly.

The present invention has an object to provide an image compressing apparatus which further generates data compressed and coded at a different compression rate, rapidly and easily, without decoding given code data to wavelet coefficients, and an image compressing method therefor.

According to the present invention, an image compressing apparatus has code data input thereto, which code data comprises data of codes and additional information, the data of codes being one which is once created from compressing, for each processing unit at a predetermined first compression rate, coefficient data obtained from analyzing given image data with respect to frequency, the additional information being data necessary for decoding the data of codes. The image compressing apparatus includes: a memory storing at least data of codes of the code data; a code amount calculating part calculating, from the code data, a first total data amount of codes for each processing unit; a code amount control part obtaining a second total data amount of codes for each processing unit from the first data amount of codes for each processing unit calculated by the code amount calculating part, which second data amount is a data amount which should be obtained when image data obtained from decoding the code data is again compressed and coded at a predetermined second compression rate higher than the predetermined first compression rate; and a code creation part creating recompressed code data by updating the additional information to information for the thus-recompressed state, and reading the data of codes for each processing unit from the memory for the thus-obtained second total data amount in a predetermined manner.

In this configuration, the given code data is not completely decoded to image data, and, with the use of the given code data, it is possible to create code data which is one obtained from compressing image data, which is obtained from decoding the given code data, at a higher compression rate, without completely decoding the given code data. Thereby, it is possible to reduce a time required for the operation processing.

In the above-mentioned image compressing apparatus, the predetermined manner of reading the data of codes for each processing unit from the memory performed by the code creation part may be to read in an order such that data of codes, which are those concerning more significant bit data of the coefficient data if they are decoded, is read earlier.

In this configuration, with the use of the given code data, it is possible to create code data which is one obtained from compressing and coding image data obtained from decoding the code data, at a higher compression rate at high accuracy, without completely decoding the given code data. Thereby, it is possible to reduce a time required for the operation processing.

Any one of the above-mentioned image compressing apparatuses may have the code data input thereto, which code data is obtained from once coding according to JPEG2000, and comprises the data of codes and the additional information, the additional information comprising code information indicating the number of zero bit planes for each processing unit, and the data of codes comprising MQ codes. The memory may store the code information and the data of MQ codes for each processing unit; and the code amount control part may obtain the second total data amount of MQ codes for each processing unit to be obtained if the image data obtained from actually decoding the code data is compressed at the second predetermined compression rate, from a total data amount of MQ codes for each processing unit obtained from performing entropy decoding processing according to JPEG2000 on the code data and a data amount of MQ codes for each coding path.

In this configuration, the given code data, which is one once coded according to JPEG2000, is not completely decoded to image data, and, with the use of the given code data, it is possible to create code data which is one obtained from compressing image data, which is obtained from decoding the given code data, then at a higher compression rate. Thereby, it is possible to reduce a time required for the operation processing.

The above-described image compressing apparatus may include: a coding part compressing and coding the image data according to JPEG2000 and creating the code data comprising the additional information and the data of MQ codes; and a decoding part decoding the code data having a configuration comprising the additional data and the data of MQ codes into image data.

The image compressing apparatus in this configuration can perform not only recompression of given code data but also compression and coding of image data according to JPEG2000 and further decoding the thus-obtained code data.

An image compressing method, according to the present invention, having code data input thereto, which code data comprises data of codes and additional information, the data of codes being one once created from compressing, for each processing unit at a predetermined first compression rate, coefficient data obtained from analyzing given image data with respect to frequency, the additional information being data necessary for decoding the data of codes, and after that, creating code data obtained from compressing at a different compression rate, has the steps of: a) storing at least data of codes of the code data in a memory; b) calculating, from the code data, a first total data amount of codes for each processing unit; c) obtaining a second total data amount of codes for each processing unit from the first data amount of codes for each processing unit calculated in said step b), which second data amount is a data amount obtained if image data obtained from decoding the code data is again compressed and coded at a predetermined second compression rate higher than the predetermined first compression rate; and d) creating recompressed code data by updating the additional information to information for the recompressed state, and then reading out the data of codes for each processing unit from the memory for the second total data amount in a predetermined manner.

In this configuration, with the use of given code data, it is possible to create code data which is one obtained from compressing and coding image data obtained from decoding the code data, at a higher compression rate at high accuracy, without completely decoding the given code data. Thereby, it is possible to reduce a time required for the operation processing.

### BRIEF DESCRIPTION OF THE DRAWINGS

Other objects and further features of the present invention will become more apparent from the following detailed description when read in conjunction with the accompanying drawings:

FIG. 1 shows a configuration of an image processing apparatus according to a first embodiment of the present invention;

FIGS. 2A, 2B, 2C and 2D illustrate a general concept of processing carried out by the image processing apparatus shown in FIG. 1;

FIG. 3 shows a memory map of an MQ code storage memory shown in FIG. 1;

FIG. 4 shows a configuration of a pass code amount calculating part shows in FIG. 1;

FIG. 5 shows a configuration of a code amount control part shown in FIG. 1;

FIG. 6 shows a configuration of a code creation part shown in FIG. 1;

FIG. 7 shows a time chart showing signal states in the code creation part;

FIG. 8 shows a configuration of a CB control part shown in FIG. 6; and

FIG. 9 shows a configuration of an image compressing apparatus according to a second embodiment of the present invention.

### DETAILED DESCRIPTION OF THE PREFERRED EMBODIMENTS

(1) General Concept

First, a general concept of embodiments of the present invention is described.

According to the present invention, an image compressing apparatus is configured so that, code data which is once coded according to JPEG2000 is received, and then additional information (meaning a packet header including code information indicating the number of zero bit planes and so forth) required for decoding the code data and data of MQ codes are once stored in a memory, without decoding the given code data to wavelet coefficients. With the use of information required for performing entropy decoding on the code data, a total data amount of MQ codes, from which code data is created if compression and coding are performed again at a different compression rate (higher than the previous one), is determined. Then, from the above-mentioned memory, in an order starting from data of MQ codes which become the most significant bit data in the wavelet coefficients if the code data is actually decoded, data of MQ codes is read out for the above-mentioned determined total data amount. Also, the above-mentioned additional information is updated to have values for the thus obtained recompressed code data. Therefrom, the code data is re-created in a different compression rate, and output.

By providing such a recompression function, it is not necessary to perform decoding given code data into wavelet coefficients and then perform entropy coding again, even for the purpose of creating code data compressed at a different compression rate. Accordingly, it is possible to reduce the necessary operation amount (i.e., to eliminate coefficient modeling processing and MQ coding processing), and also, to reduce the require processing operation time accordingly.

(2) First Embodiment

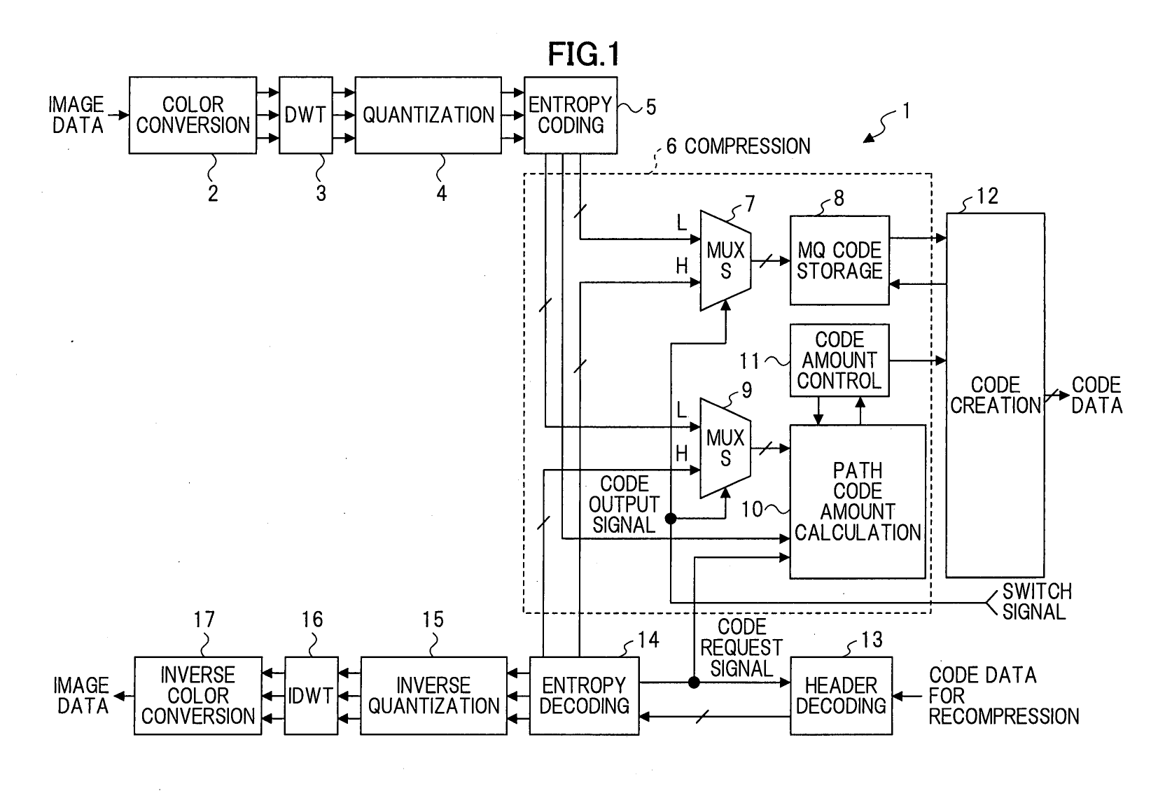

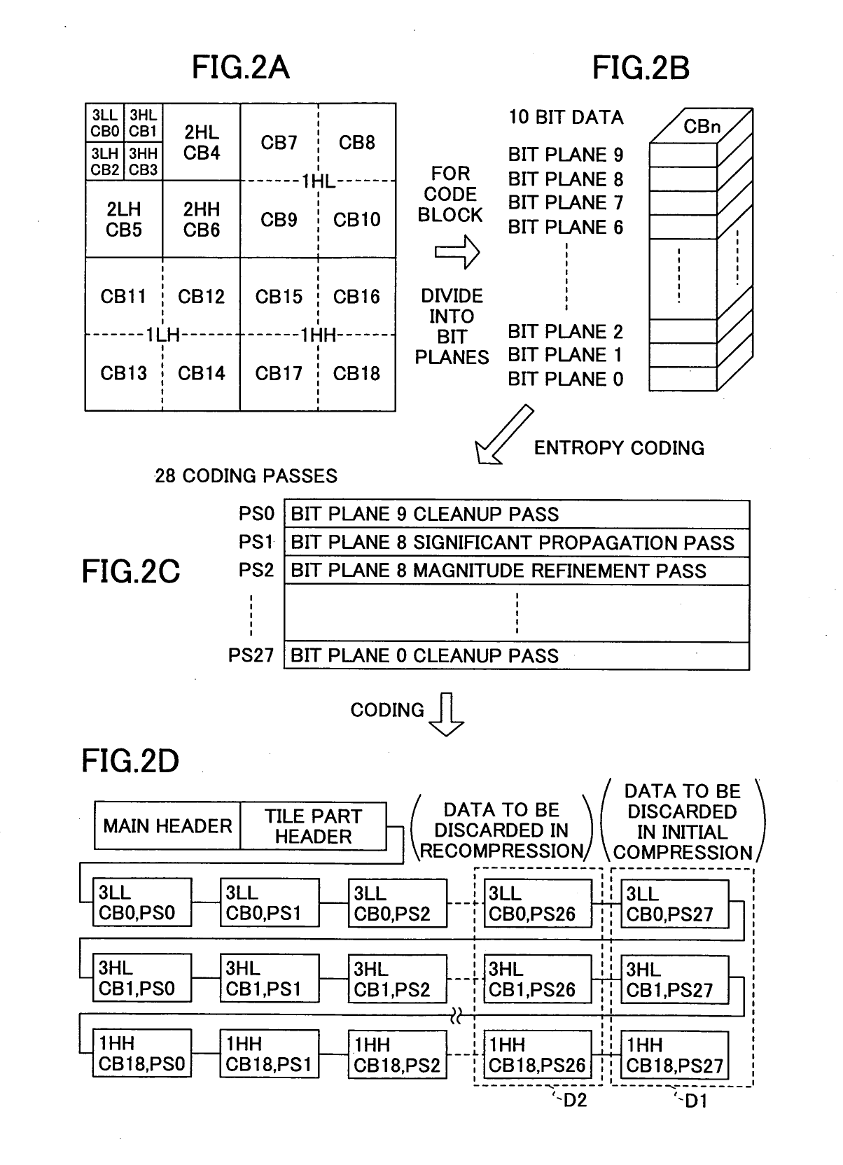

An image compressing apparatus according to a first embodiment of the predetermined is described next with reference to the figures. FIG. 1 shows a configuration of the image compressing apparatus 1 according to the first embodiment. The image compressing apparatus 1 has the above-mentioned recompressing function, and also, a function of coding image data according to JPEG2000, and a function of decoding code data reversely. FIG. 2 illustrates a general concept of image data compression and coding processing carried out by the image compressing apparatus 1. The image compressing apparatus 1 includes, as shown, a color conversion part 2, a DWT part 2, a quantization part 3, an entropy coding part 5, a compression part 6, a code creation part 12, a header decode part 13, an entropy decoding part 14, an inverse quantization part 15, an IDWT part 16 and an inverse color conversion part 17.

For the purpose of easy understanding of the processing contents, coding of image data and decoding code data according to JPEG2000 carried out by the image compressing apparatus 1 are described first, and then, recompression of code data is described next. The processing contents already realized by hardware and software according to JPEG2000 are described briefly.

(2-1) Coding and Decoding Processing According to JPEG2000

Image data input is separated into respective color components, i.e., Y, Cb and Cr by the color conversion part 2. The data thus obtained is then caused to undergo two-dimensional discrete wavelet transform in a level 2 which is a first method of frequency analysis by the DWT part 3. Thereby, for the data for each color component, as shown in FIG. 2A, two-dimensional discrete wavelet coefficients, each 10-bit data, is obtained, configured by respective subbands, i.e., 3LL, 3LH, 3HL, 3HH, 2HL, 2LH, 2HH, 1HL, 1LH and 1HH. These wavelet coefficients are caused to undergo scalar quantization in the quantization part 4.

The entropy coding part 5 divides the thus-quantized wavelet coefficients into 19 codes blocks CB0 through CB18, as shown in FIG. 2A. Furthermore, as shown in FIG. 2B, the entropy coding part 5 divides each code block into 10 bit planes, i.e. . . bit planes 0 through 9. Then, as shown in FIG. 2C, the entropy coding part 5 performs so-called coefficient modeling, and after that, performs MQ coding, for each code block. Specifically, the entropy coding part 5 performs scanning the given wavelet coefficients in predetermined three types of methods in an order starting from the bit plane which is located at the top under a condition in which zero bit planes are removed. The zero bit planes mean bit planes which include no significant data (data having a value “1”), and the number of the zero bit planes is zero (ZBP=0) in this example. Code information which indicates the number of zero bit planes ZBP is included in a packet header which is included in code data finally output. The packet header is additional information required for decoding the relevant code data. The above-mentioned three types of scanning methods includes so-called “cleanup pass”, “significant propagation pass” and “magnitude refinement pass” (i.e., three types of coding passes), respectively.

According to JPEG2000, for the data on the most significant bit plane N (N=9 when the number of zero bit planes ZBP is 0) from among the data excluding zero bit planes, scanning of only “cleanup pass” is performed. In the example shown in FIG. 2B, the number of zero bit planes is 0, and, as shown in FIG. 2C, by means of the above-mentioned scanning and arithmetic coding, MQ codes for total 28 coding passes PS0 through PS27 are generated, where 1+9×3=28. As shown, a coefficient ‘i’ of each coding pass PSi is determined as 0, 1, 2, . . . , in an order from the most significant coding pass toward the least significant coding pass.

For the purpose of simplification of description, it is assumed that each of the above-mentioned coding passes which may amount to the maximum 28 passes is identified by a respective one of PS0 through PS27 without regard to the value of the number of zero bit planes ZBP. For example, the coding passes obtained when the number of zero bit planes ZBP is 1 are identified by PS3 through PS27, respectively.

The entropy coding part 5 outputs the data of MQ codes of the above-mentioned coding passes PS0 through PS27 as well as the coding information (the number of zero bit planes ZBP) to a multiplexer 7 in the compression part 6, and also, according to JPEG2000, outputs a bit count value, a pass count value and a pass finish signal to a multiplexer 9 in the compression part 6. The bit count value is a value which identifies a bit plane which is currently processed; the pass count value is a value which identifies a coding pass (“cleanup pass”, “significant propagation pass” or “magnitude refinement pass”) which is currently processed, and, specifically, is expressed by the numerals “0”, “1” or “2” representing each of these coding passes in the stated order; and the pass finish signal is a signal indicating finish of processing of the coding pass for the bit plane currently processed, and is a pulse signal having a high level. The entropy coding part 5 outputs the pass finish signal when the pass count value of “0” is output for the most significant bit plane excluding the zero bit planes, while it outputs the pass finish signal when the pass count value of “2” is output for each of the other bit planes.

The entropy coding part 5 outputs the data of MQ codes in byte units, and, when outputting the data of MQ codes, the entropy coding part 5 outputs an MQ code output signal to a pass code calculating part 10 in the compression part 6. In a case of recompression of code data described later, the entropy decoding part 14 outputs an MQ code request signal to the above-mentioned pass code amount calculation part 10 (and also to the header decode part 13).

The above-mentioned color conversion part 2, the DWT part 3, the quantization part 4 and the entropy coding part 5 are processing parts according to JPEG2000, and have been already realized by hardware or software.

As shown in FIG. 2D, code data generated from coding processing according to JPEG2000 has a configuration of a bit stream based on the data obtained from the above-mentioned entropy coding processing, in which a main header, a tile part header, data of MQ codes of coding passes obtained for each code block are arranged in such an order that data of MQ codes of the coding pass PS0 of the code block CB0 in 3LL; data of MQ codes of PS1; . . . ; data of MQ codes of the coding pass PS0 of the code block CB1 in 3HL; data of MQ codes of PS1; . . . ; and data of MQ codes of the coding pass PS27 of the code block CB18 in 1HH).

Before creating the code data having the above-mentioned configuration, the image compressing apparatus 1 performs processing of compressing the code amount by discarding (or replacing with ‘0’ data) data of MQ codes of coding passes corresponding to the least significant bit plane. For example, as shown in FIG. 2D, the data of MQ codes of the coding pass PS27 which is 27th in each code block is discarded, and thus the code amount is reduced accordingly.

Such image compression processing is performed by the compression part 6 enclosed by a broken line in FIG. 1. The code creation part 12 creates code data with the use of data of MQ codes and the code information obtained after the image compression processing is thus performed, and outputs the same. Configurations and operations of the above-mentioned compression part 6 and the code creation part 12 will be described later in detail when recompression processing is described.

The image compressing apparatus 1 also has a function of decoding code data once obtained from coding given image data into the original image data according to JPEG2000. Specifically, the header decode part 13 analyzes input code data, extracts a header part (including the main header and the tile part header) and the data of MQ codes separately, outputs, from the header part, data indicating the code information (the number of zero bit planes ZBP), the number of coding passes and the number of bytes of the MQ codes for each code block, and outputs, in response to the MQ code request signal from the entropy decoding part 14, the data of MQ codes in byte units.

The entropy decoding part 14 performs decoding based on the above-mentioned code information and the data of MQ codes input from the header decode part 13, and thus obtains data of wavelet coefficients in a quantized state. Similar to the above-mentioned entropy coding part 5, the entropy decoding part 14 outputs the data of MQ codes of the coding passes PS0 through PS27, and the data of coding information (the number of zero bit planes ZBP) to the multiplexer 7 in the compression part 6, and also, according to JPEG2000, the bit count value (0 through 9) indicating the bit plane currently processed, the pass count value (‘0’, ‘1’ or ‘2’, representing the following three coding passes, respectively) indicating a type of the coding pass (“cleanup pass”, “significant propagation pass” or “magnitude refinement pass”) currently processed, and the pass finish signal indicating finish of the coding pass currently processed to the multiplexer 9 in the compression part 6. Further, the entropy decoding part 14 outputs the MQ code request signal to the header decode part 13 and to the pass code amount calculation part 10 in the compression part 6.

The inverse quantization part 15 performs inverse quantization of the given wavelet coefficients in the quantized state, and outputs the inverse quantization result. The IDWT part 16 then performs inverse two-dimensional wavelet transform processing. The inverse color conversion part 17 then converts data in each color component Y, Cb or Cr obtained from the inverse wavelet transform processing into image data, and outputs the image data.

The above-mentioned header decode part 13, the entropy decoding part 14, the inverse quantization part 15, the IDWT part 16 and the inverse color conversion part 17 are processing parts according to JPEG2000 and have been already realized by hardware or software.

(2-2) Code Data Recompression Processing

The image compressing apparatus 1 has the above-mentioned recompression function of recompressing code data once compressed, then at a different compression rate (higher than before). This recompression function is a function of outputting code data in which the data of MQ codes of the coding passes PS26 (indicated as D2 in FIG. 2D) on the least significant bit plane is further discarded. Superficially, for this purpose, a configuration is provided in the image compressing apparatus 1 such that, for example, code data is input in a state in which, by means of predetermined switching operation, a switching signal normally having a low level is switched to have a high level, and thereby, in such a state, the code data is not decoded into wavelet coefficients, but the code information (the number of zero bit plane ZBP) and the data of MQ codes obtained from analyzing the given code data are once stored in the memory 8, and also, with the use of predetermined information required for performing entropy decoding, a packet header is created and output, which includes coding information (the number of zero bit planes ZBP), a code amount of code blocks and the number of coding passes for each code block, which should be obtained assuming that compression and coding processing is performed at a higher compression rate. Further, data of MQ codes are read out from the memory for a total data amount of MQ codes of each code block which should be obtained assuming that the compression and coding processing is performed at the above-mentioned higher compression rate.

The compression part 6 includes the two multiplexers 7, 9, the MQ code storage memory 8, the pass code amount calculation part 10 and the code amount control part 11. As described above, from the entropy coding part 5 and the entropy decoding part 14 according to JPEG2000, data of MQ codes of coding passes PS0 through PS27 and data of code information (the number of zero bit planes ZBP) are output to the multiplexer 7, while, according to JPEG2000, a bit count value (having a value in a range between 0 and 9) indicating a bit plane currently processed, a pass count value (having a value of 0, 1 or 2, representing a respective one of the three types of coding passes) indicating a type of coding pass (“cleanup pass”, “significant propagation pass” or “magnitude refinement pass”) currently processed and a pass finish signal indicating finish of processing of the bit plane currently processed are output to the multiplexer 9.

The above-mentioned switching signal input to respective input terminals S of the above-mentioned multiplexers 7 and 9 is switched to have the high level by means of switching operation of a switch not shown. Each of the multiplexers 7 and 9 passes the signals input from the entropy coding part 5 therethrough when the switching signal provided to its terminal S has the low level, while passing the signals input from the entropy decoding part 14 therethrough when the switching signal provided to its terminal has the high level.

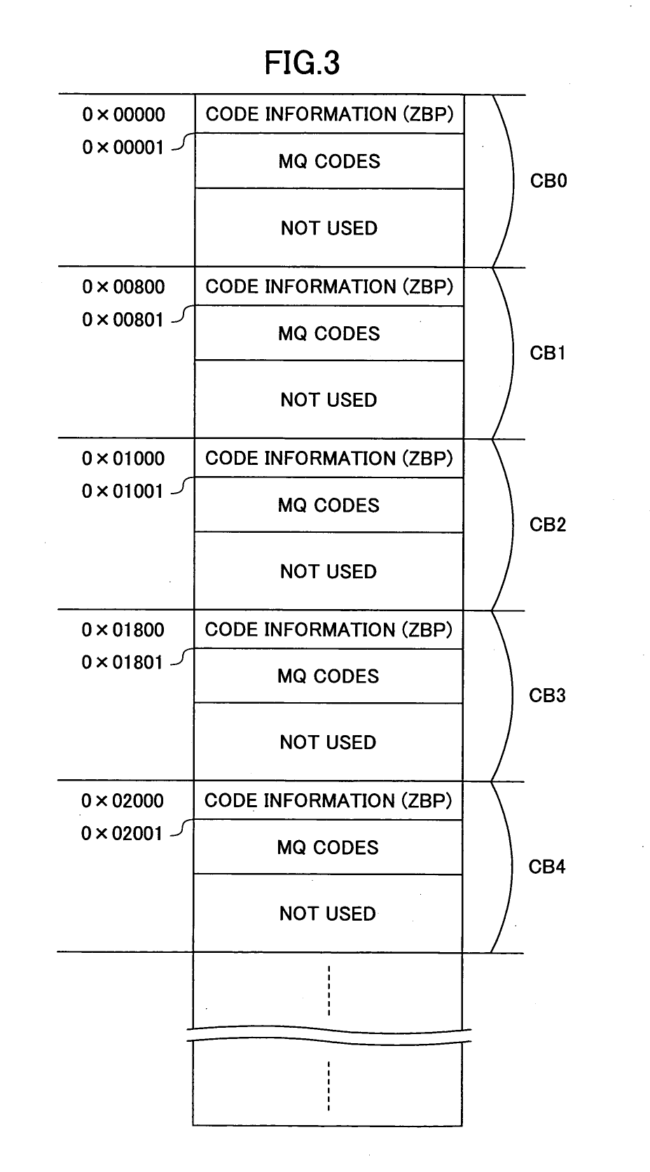

The MQ code storage memory 8 stores 1-byte data indicating the above-mentioned code information (the number of zero bit planes ZBP) and the data of MQ codes for the code blocks CB0 through CB18 output from the multiplexer 7 at an area allocated in 800-byte units, in sequence (see a memory map shown in FIG. 3).

The pass code amount calculation part 10 calculates a total data amount (the number of bytes) of MQ codes of each of the code blocks CB0 through CB18 and a data amount (the number of bytes) of MQ codes of each of the coding passes PS0 through PS27 in the MQ codes obtained from the entropy coding or the entropy decoding.

The code amount control part 11 obtains an ideal data amount after compression by multiplying the total data amount of each code block thus obtained in the pass code amount calculation part 10 by a previously set compression ratio. Then, data amounts of the MQ codes of the coding passes are accumulated in an order starting from the most signification bit plane until the thus-obtained accumulated value exceeds the above-mentioned ideal data amount. Then, when the accumulated value exceeds the ideal data amount, in order that the thus-accumulated data of MQ codes accumulated up to the immediately preceding coding pass may create code data, the code amount control part 11 updates the total data amount of MQ codes up to the immediately preceding coding pass for each code block and the information of the number of coding passes in the relevant code block in the same condition, and outputs the updated information to the code creation part 12.

The code creation part 12 updates the code information based on the updated total data amount (the number of bytes) of MQ codes for each code block after compression and the updated information of the number of coding passes in the relevant code block thus output from the code amount control part 11 of the compression part 6, then reads out data from the data of MQ codes of each code block stored in the MQ code storage memory 8 for the above-mentioned updated total data amount for each code block, and thus creates the code data according to JPEG2000 with the thus-read-out data in a form of a code stream.

(2-3) Detailed Configuration of Each Part in Compression Part

(2-3-1) Pass Calculation Part

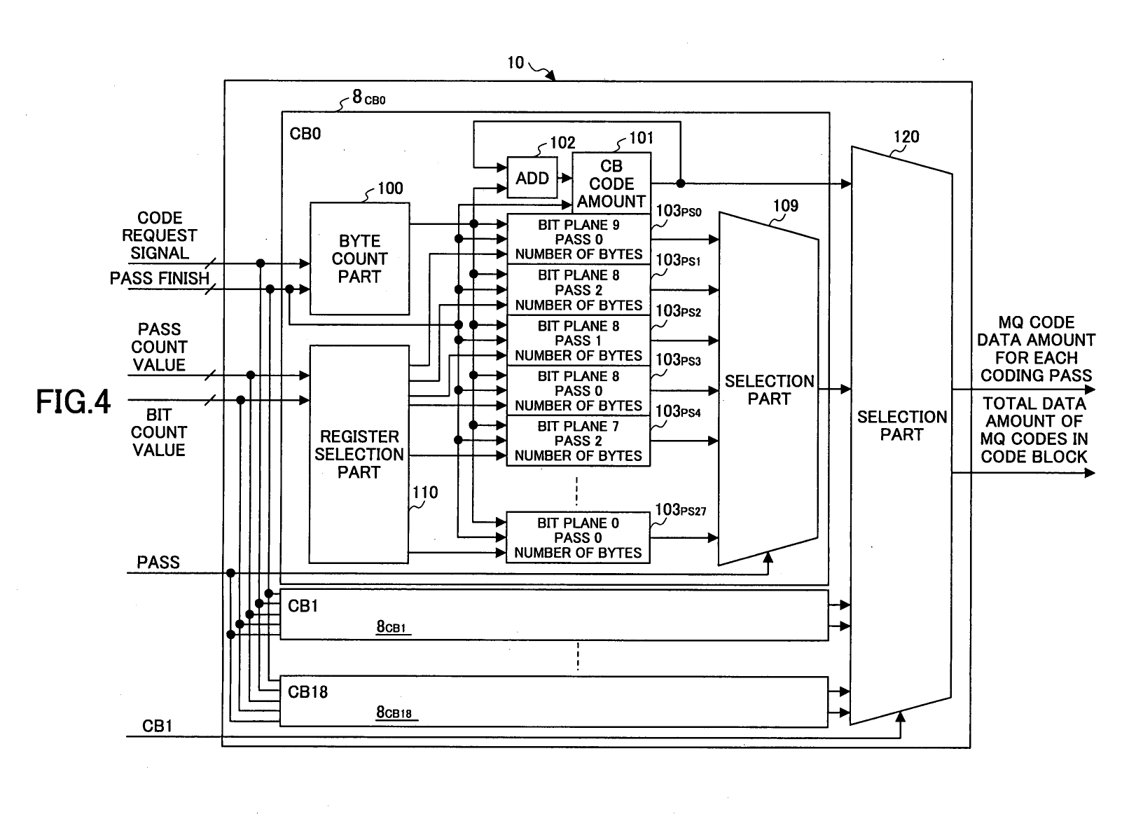

FIG. 4 shows a detailed configuration of the pass code calculation part 10. The pass code calculation part 10 includes 19 code block amount calculation parts 8_{CB0} through 8_{CB18} and a selection part 120. At a time of recompression, the MQ code request signal is input to each of these code block amount calculation parts from the header decode part 13; the pass finish signal, the pass count value and the bit count value for the relevant code block for each code block are input in parallel to a respective one of these code block amount calculation parts from the entropy decoding part 14; and a ‘PASS’ signal (0 through 27) described later indicating the coefficient ‘i’ (‘i’ having a value in a range between 0 and 27) of a coding pass PSi currently processed is input thereto from the code amount control part 11. Further, the selection part 120 has a ‘CB1’ signal (0 through 18) indicting a coefficient ‘n’ (‘n’ having value in a range between 0 and 18) of a code block CBn currently processed described later input thereto from the code amount control part 11.

Each code block amount calculation part has the same configuration, description is made only for the code block code amount calculation part 8_{CB0}, and duplicate description for the other code block code amount calculation parts 8_{CB1} through 8_{CB18} is omitted.

A byte count part 100 shown counts the number of the code request signals output from the header decode part 13, i.e., the number of bytes of MQ codes currently processed, and outputs the count value to one signal input terminal of a two-input adder 102, and to respective data input terminals of total 28 registers 103_{PS0} through 103_{PS27}. Further, the byte count part 100 resets its count value in response to an input of the pass finish signal (PASS FINISH).

The output terminal of the adder 102 is connected to a data input terminal of a register 101, and the output of the register 101 is input to the other input terminal of the adder 102 in a feedback manner. The register 101 holds an added value output from the adder 102 when the pass finish signal is input, and outputs the same. In other words, each time when an amount (the number of bytes) of MQ codes of coding passes of each bit plane is obtained, the register 101 outputs the accumulated value (the number of bytes) of the amount of MQ codes of these coding passes, and finally, outputs the total data amount of MQ codes of the coding block CB0.

The above-mentioned pass finish signal is also input to the total 28 registers 103_{PS0} through 103_{PS27}. In each register 103_{PS0} through 103_{PS27}, data indicating a code amount (the number of bytes) of the coding pass corresponding to the relevant pass count value 0, 1 or 2 is stored in an order from the least significant bit plane 0. Specifically, a register selection part 110 identifies a coding pass PSi (‘i’ has a value in a range between 0 and 27) currently processed, from the pass count value and the bit count value, and enables the register 103_{PSi} determined by the thus-identified value. The enabled register 103_{PSi} holds the count value (the number of bytes) output from the byte count part 100 when the pass finish signal is input, and outputs the same to the selection part 109.

The selection part 109 outputs the data indicating the MQ coding amount of the coding pass PSi′ which is output from the register 103_{PSi}, designated by a value i′ (where i′=i+3×ZBP) corrected, according to the number of zero bit plane ZBP, from the value i of the PASS signal input from code amount control part 11.

The selection part 120 outputs the data amount of MQ codes of the above-mentioned coding pass PSi′ and the total data amount of MQ codes of the code block CBn from the code block amount calculation part 8_{CBn} for the code block CBn designated by the value n of the CB1 signal input from the code amount control part 11.

(2-3-2) Configuration of Code Amount Control Part

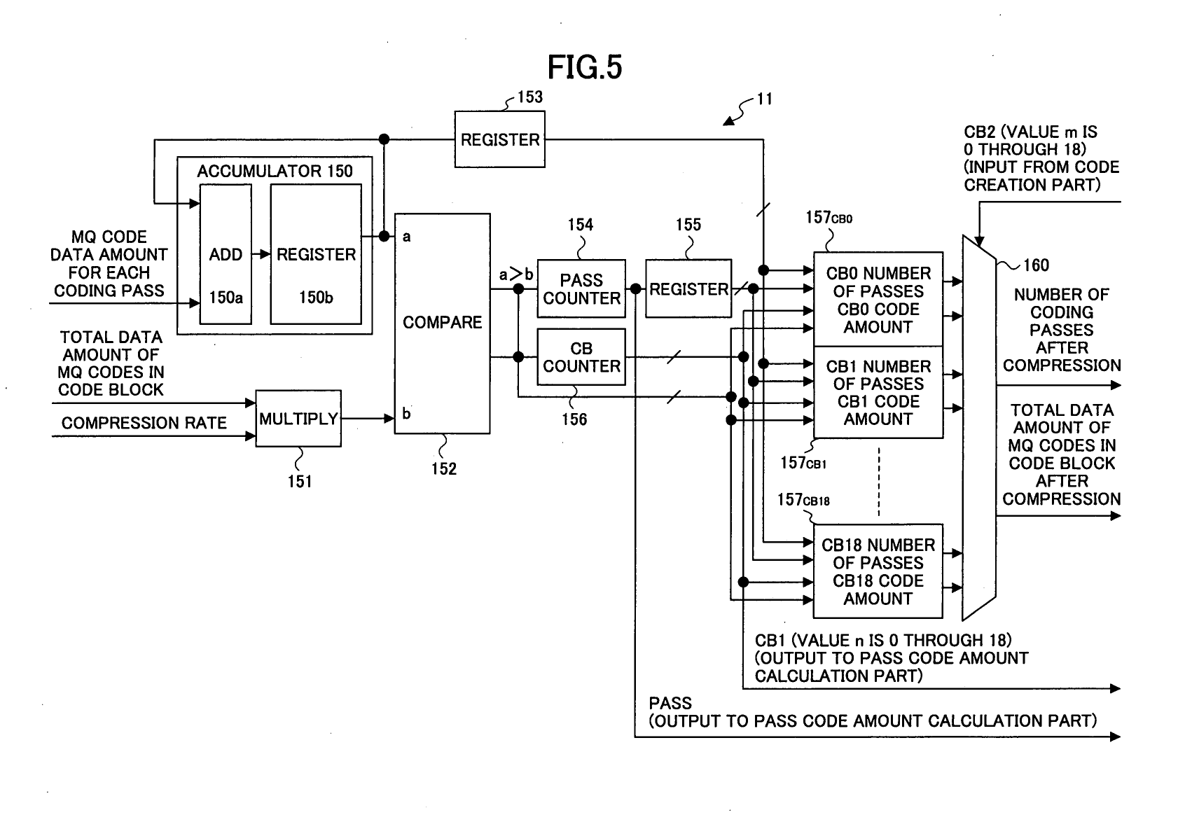

FIG. 5 shows a configuration of the code amount control part 11. The code amount control part 11 outputs the CB1 signal (having a value in a range between 0 and 18) having the value n to designate the code block CBn to be processed (from a CB counter 156) and the PASS signal (having a value in a range between 0 and 27) having the value i′ to designate the coding pass PSi′ to be processed (from a pass counter 154) to the above-mentioned pass code amount calculation part 10. The code amount calculation part 10 responds to the thus-input CB1 signal and PASS signal to output the total data amount of MQ codes of the code block CBn and the data amount of MQ codes of the coding pass PSi′ in the code block CBn to the code amount control part 11.

In the code amount control part 11, an adder 151 multiplies the total data amount of MQ codes of the code block CBn input from the pass code amount calculation part 10 by the prescribed compression ratio so as to obtain the above-mentioned ideal data amount (the number of bytes), and outputs the same to a signal input terminal b of a comparator 152. An accumulator 150 obtains an accumulation of the data amount of MQ codes of the coding pass PSi′ input, outputs the thus-obtained accumulated value to a signal input terminal a of the comparator 152, and also, outputs the same to a register 153 which holds an immediately preceding accumulated value so as update the value in the register 153 therewith. The accumulator 150 includes, as shown, a two-input adder 150a which adds the data amount MQ codes of the coding pass PSi′ and the already accumulated value input thereto in a feedback manner, and a register 150b which holds the output of the adder 150a and outputs the same.

The register 153 outputs the data of the accumulated value held there, as data indicating the number of coding passes included in the code block CBn designated by the value n of the CB1 signal, to 19 registers 157_{CB0} through 157_{CB18}. This data is however actually held only by the register 157_{CBn} which is enabled by the count value n output from a CB counter 156, as described later.

The comparator 152 outputs a comparison result signal having a low level until the accumulated value (byte unit) input to the input terminal a exceeds the ideal data amount (byte unit) input to the input terminal b, and outputs the comparison result signal having a high level when the accumulated value exceeds the ideal data amount.

The pass counter 154 counts up at predetermined timing during input of the low level of the comparison result signal, outputs the thus-updated count value to a register 155 which holds the immediately preceding count value so as to update the count value therewith, and also, outputs the same to the pass code calculation part 10 as the PASS signal. Furthermore, the pass counter 154 resets the count value in response to switching to the high level of the comparison result signal.

The CB counter 156 performs counting up each time the comparison result signal is switched to the high level, outputs the count value n to respective data writing enable terminals of the registers 157_{CB0} through 157_{CB18}, and also, outputs the count value to the pass code calculation part 10 as the CB1 signal. Among the registers 157_{CB0} through 157_{CB18}, the registers 157_{CBn} for the code block CBn designated by the count value n is enabled, and thereby writing to this register is enabled.

The register 155 writes the data indicating the number of coding passes immediately before the comparison result signal is switched to the high level, to the one of the 19 registers 157_{CB0} through 157_{CB18}, which has been enabled as mentioned above.

A selection part 160 outputs the total data amount of MQ codes and the number of coding passes of the code block CBm output from the registers 157_{CBm} designated by the value m of a CB2 signal output from the code creation part 12, described later, to the code creation part 12 connected subsequently.

(2-3-3) Configuration of Code Creation Part

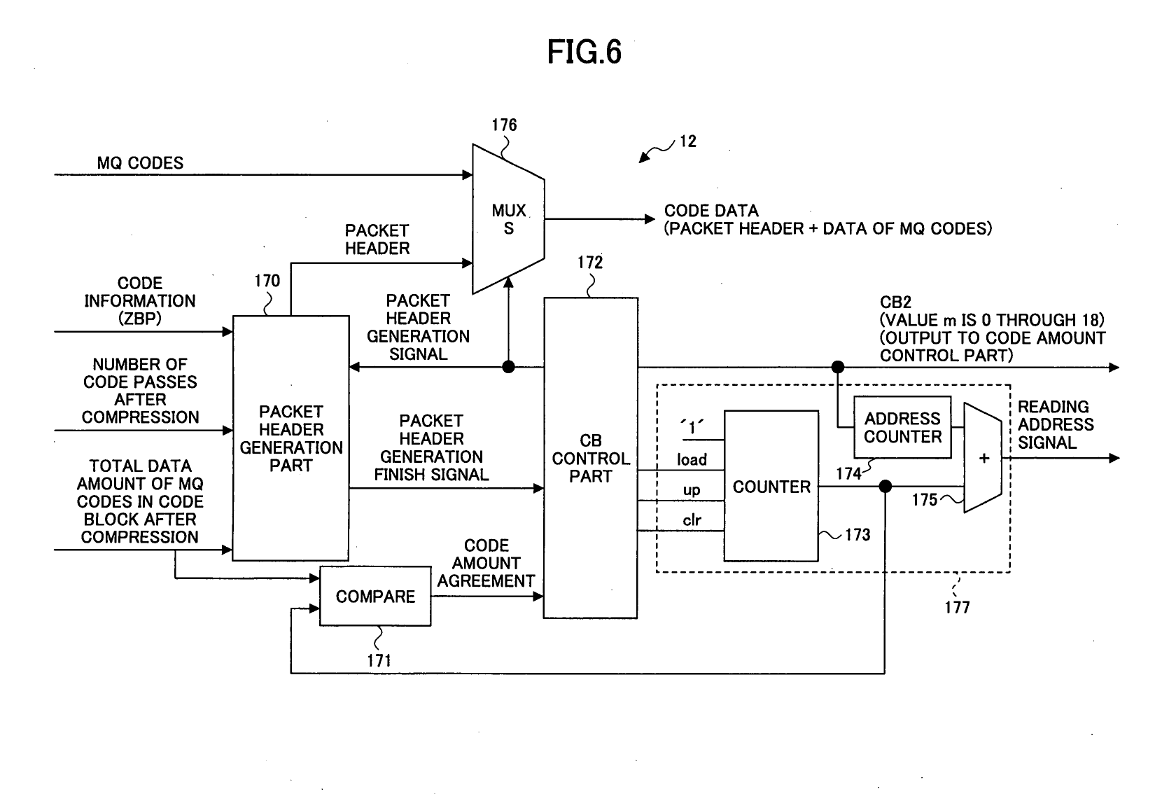

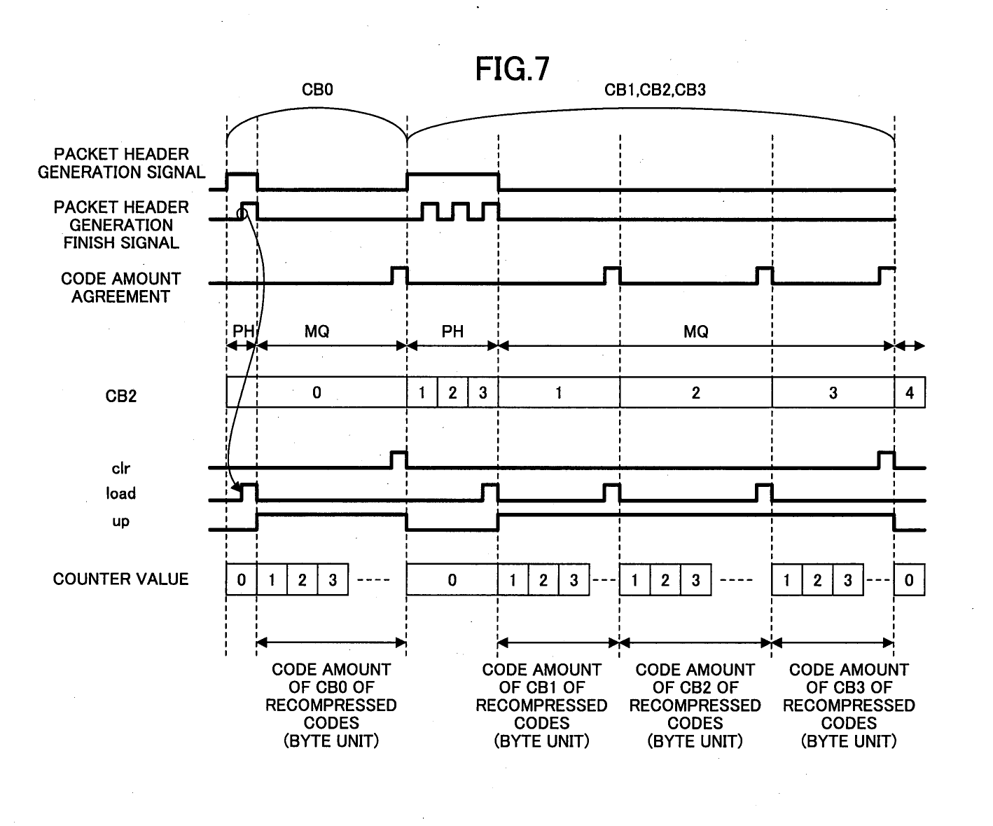

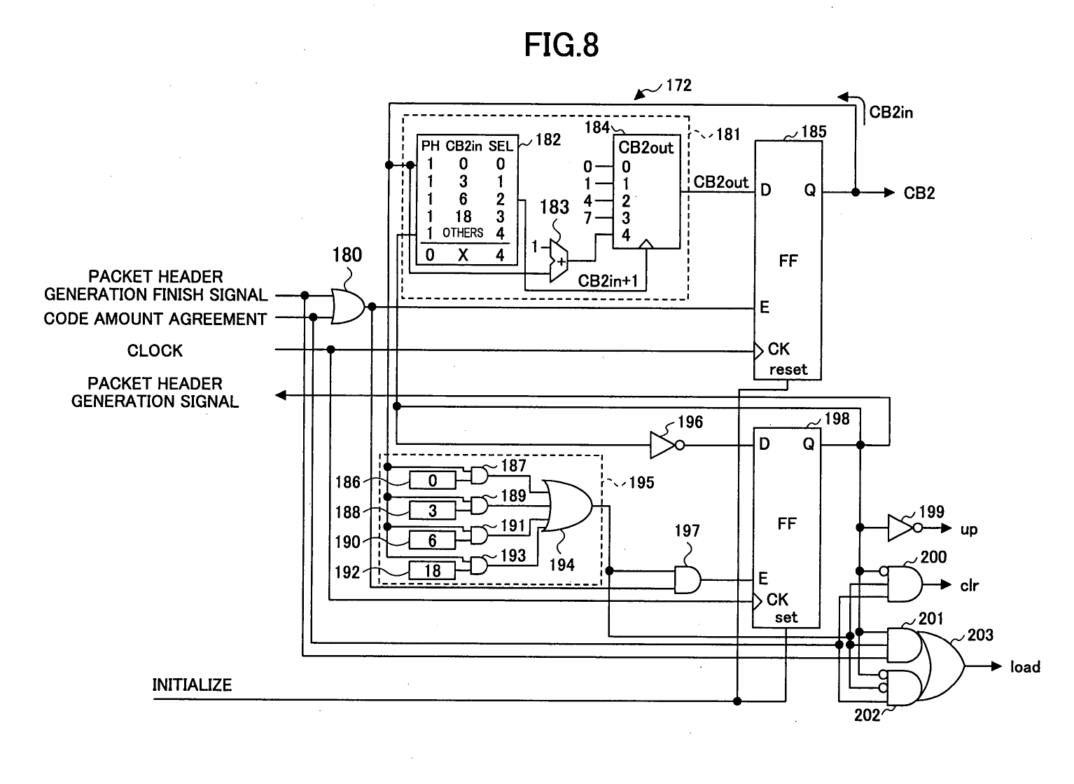

FIG. 6 shows a configuration of the code creation part 12. FIG. 7 shows states of the respective signals when code data is output after, for example, the code blocks CB0, CB1, CB2 and CB3 are recompressed. FIG. 8 shows a configuration of a CB control part 172 included in the code creation part 12. After the code creation part 12 is described with reference to FIGS. 6 and 7, the configuration of the CB control part 172 is described next.

The code creation part 12 updates the packet header with the use of the code information (the number of zero bit planes ZBP) as well as the above-mentioned total code amount of MQ codes and the number of coding passes for the code block after the recompression obtained from the code amount control part 11, outputs the same, and, after that, reads out the data of MQ codes from the MQ code storage memory 8 until the thus-read-out data amount reaches the above-mentioned total data amount after the recompression. At this time, an order of the reading out from the data of the codes stored in the MQ code storage memory 8 is such that the data which affects the most significant bit data of the coefficient data if it is decoded may be read out first.

The CB control part 172 outputs the CB2 signal (having the value m in a range between 0 and 18) designating the code block m to be processed, to the code amount control part 11, and also, causes an address generation part 177 to generate an address signal for reading out data of the code information (the number of zero bit planes ZBP) of the code block CBm from the MQ code storage memory 8. Further, along with outputting the CB2 signal as mentioned above, the CB control part 172 outputs a packet header generation signal having a high level to a packet header generation part 170 and to a selection signal input terminal S of a multiplexer 176 (see FIG. 7).

The packet header generation part 170 includes a plurality of registers, and, during the above-mentioned packet header generation signal having the high level being input, generates the packet header in which the total data amount of the code block CBm after the recompression and the number of coding passes output from the code amount control part 11 and the code information (the number of zero bit planes ZBP) read out from the storage memory 8 are disposed according to a predetermined order, and outputs the thus-generated packet header to the multiplexer 176.

The multiplexer 176 outputs the signal of the packet header 170 as the code data while the high level of the packet header generation signal is received from the CB control part 172 to the selection signal input terminal S thereof.

The packet header generation part 170 outputs a packet header finish signal having a high level to the CB control part 172 when generation and outputting of the packet header is completed (see FIG. 7). The CB control part switches the packet header generation signal to a low level in response to the high level of the packet header finish signal being thus input, and, continuously, causes the address generation part 177 to output an address signal for reading out the data of MQ codes of the code block CBm in one-byte unit.

A configuration of the address generation part 177 is described next. The address generation part 177 includes a counter 173, an address counter 174 and an adder 175. The address counter 174 outputs a value obtained from multiplying the value of the CB2 signal by 800 (in hexadecimal notation), as the 5 bits from the MSB of the data reading address in 2 bytes. The counter 173 outputs the count value, as the 11 bits from the LSB of the data reading address signal in 2 bytes to be output to the memory 8. Specifically, the counter 173 counts up at predetermined timing while a high level of an up signal is input, and resets the count value in response to a high level of a clr signal being input. Further, in response to a high level of a load signal being input, the counter 173 outputs a value “1” as it is. The adder 175 creates the total two bytes of the reading address signal from the outputs of the counter 173 and the address counter 174, and outputs the same.

As shown in FIG. 3, 1-byte code information for the code blocks CB1, CB2, CB3, . . . are stored every 800 bytes, i.e., in address of 0×00000, 0×00800, 0×01000, . . . in hexadecimal notation. Data of MQ codes are written from the address of 0×00001, 0×00801, 0×01001, . . . As shown in FIG. 7, in response to the high level of the packet header generation finish signal being input, the CB control part 172 outputs the load signal at the high level, so as to cause the least significant bit of the address output from the address generation part 177 to be “1”. Thereby, the data of MQ codes of the code block CBm is read for one byte from the MQ code storage memory 8. After that, the CB control part 172 switches the above-mentioned packet header generation signal and the load signal into the low levels, and also, switches the up signal to the high level. After that, the counter 173 continues counting up until the high level of the clr signal is input.

As described above, the count value of the counter 173 of the address generation part 177 corresponds to the 11 bits from the LSB of the data reading address signal in two bytes output to the memory 8, and also, this value indicates the number of bytes of MQ codes to read out from the memory 8. The comparator 171 compares the value of the total data amount (the number of bytes) of MQ codes after the recompression of the code block CBm output from the code amount control part 11, with the count value output from the counter 173, and, outputs a code amount agreement signal having a high level to the CB control part 172 when the total code amount value agrees with the count value.

The CB control part 172 switches the clr signal into the high level in response to the high level of the code amount agreement signal being input, and thus resets the count value in the counter 173 to “0”.

Continuously, creation and outputting of the code data for the code blocks CB1, CB2 and CB3 in each of the subbands 3HL, 3LH and 3HH are carried out in the same way as shown in FIG. 7. Specifically, the CB control part 172 responds to reception of the high level of the code amount agreement signal, to again switch the packet header generation signal to the high level, and also, outputs the CB2 signal after incrementing the value m by 1 so that m=1. In the same procedure as that described above, the packet header generation part 170 creates a packet header of the code block CB1, and outputs the thus-created packet header as code data via the multiplexer 176.

When the high level of the packet header finish signal is input from the packet header generation part 170, the CB control part 172 increments the value m of the CB2 signal by 1 so that m=2, and output the same. When further receiving the high level of the packet header finish signal, the CB control part 172 increments the value m of the CB2 signal so that m=3, and outputs the same. When the high level of the packet header finish signal indicating completion of generation of the packet header for the code block CB3 is input from the packet header generation part 170, the CB control part 172 switches the packet header generation signal to the low level, and performs reading of the data of MQ codes for the relevant code blocks CB1 through CB3 (see FIG. 7).

Although not shown in FIG. 7, after that, the CB control part 171 carries out generation of the packet header and reading of the data of MQ codes for the code blocks CB4, CB5 and CB6 in the subbands 2HL, 2LH and 2HH in the same procedure. After that, the CB control part 171 carries out generation of the packet header and reading of the data of MQ codes for the code blocks CB7 through CB10, CB11 through CB14 and CB15 through CB18 in the subbands 1HL, 1LH and 1HH in the same procedure.

FIG. 8 shows a specific configuration of the CB control part 172 carrying out the above-described procedure. To one signal input terminal of two-input OR gate 180, the packet header finish signal is input, and the code amount agreement signal is input to the other signal input terminal. When any one of the packet header generation finish signal and the code amount agreement signal has the high level, the OR gate 180 outputs an enable signal having a high level to an enable terminal E of a flip flop device 185.

To a clock signal input terminal of each of flip flop devices 185 and 198, the clr signal is input. To a reset terminal reset of the flip flop device 185 and to a set terminal set of the flip flop device 198, an initialization signal is input. When the initialization signal is switched to a high level, an output of the flip flop device 185 is initialized to “1” while an output of the flip flop device 198 is initialized to “0”.

The flip flop device 185 responds to a high level of the enable signal being input, to latch a CB2out signal input to a data input terminal D, and outputs the same as the CB2 signal from an output terminal Q.

The CB2 signal output from the output terminal Q of the flip flop device 185 is also input in a feedback manner to a signal conversion part 181 as a CB2in signal. The signal conversion part 181 outputs the CB2out signal to the input terminal D of the flip flop device 185, which signal has a value corresponding distinguishably to a case where the value of the CB2 signal input when the packet header generation signal has the high level is 0, 3, 6 or 18 and a case where the same has any other value.

The signal conversion part 181 includes a selection signal generation part 182, an adder 183 which adds 1 to the value of the CB2in signal, and a multiplexer 184. The selection signal generation part 182 outputs a selection signal to a selection signal input terminal S of the multiplexer 184, according to the value of the input CB2in signal. Specifically, as shown, when the packet header generation signal (indicated as PH in the figure) has the high level (1), also, when the CB2in signal is 0, the selection signal generation part 182 outputs the selection signal of a value 0 (indicated as SEL in the figure), outputs the selection signal of a value 1 when the CB2in signal is 3, outputs the selection signal of a value 2 when the CB2in signal is 6, outputs the selection signal of a value 3 when the CB2in signal is 18, and outputs the selection signal of a value 4 when the CB2in signal has any value other than 0, 3, 6 and 18. When the packet header generation signal has the low level (0), the selection signal generation part 182 outputs the selection signal of the value 4 regardless of the value of the CB2in signal.

The multiplexer 184 outputs the CB2out signal having a value 0 when the value of the selection signal input to the selection signal input terminal S has the value 0, outputs the CB2out signal having a value 1 when the value of the selection signal has the value 1, outputs the CB2out signal having a value 4 when the value of the selection signal has the value 2, outputs the CB2out signal having a value 7 when the value of the selection signal has the value 3, and outputs the CB2out signal having a value obtained from adding 1 to the value of the CB2in signal input from the adder 183 when the value of the selection signal has the value 4.

When the CB2in signal input in the feedback manner from the flip flop device 185 is any one of 0, 3, 6 and 18, and also, when either one of the packet header generation finish signal and the code amount agreement signal has the high level, the flip flop device 198 latches an inverted signal of the packet header generation signal, and outputs the latched inverted signal as a new packet header generation signal.

Specifically, to the input terminal D of the flip flop device 198, a signal obtained from inverting the packet header generation signal output from the output terminal Q by means of an inverter 196 is input in a feedback manner. To the enable terminal E of the flip flop device 198, an output terminal of an AND gate 197 is connected. To one input terminal of the two-input AND gate 197, output of the OR gate 180 is input, and, to the other input terminal, an output terminal of a signal detection part 195 is connected. The signal detection part 195 outputs a high level only when a value of the CB2in signal which is a feedback signal of the CB2 is 0, 3, 6 or 18.

The signal detection part 195 includes registers 186, 188, 190 and 192 storing the values 0, 3, 6 and 18, respectively, AND gates 187, 189, 191 and 193 which obtain logical products between the values stored in these registers and the value of the CB2in signal, respectively, and an OR gate 194 which obtains a logical sum of outputs of these four AND gates.

By employing the above-described configuration, the flip flop device 198 enters an enable state when the CB2in signal input in the feedback manner from the flip flop device 185 is any one of 0, 3, 6 and 18 and also ether one of the packet header generation finish signal and the code amount agreement signal has the high level, and thus, outputs the new packet header generation signal.

The output of the flip flop device 198 is output as the packet header generation signal. Further, after being inverted, it is output as the up signal, also, is input to one signal input terminal of a three-input AND gate 200, which output the clr signal, after being inverted. Also, it is input to one signal input terminal of a three-input AND gate 201, which generates the load signal, and also, is input to one signal input terminal of a three-input AND gate 202, which also generates the load signal, after being inverted. A two-input OR gate 203 obtains a logical sum between outputs of the AND gate 201 and the AND gate 202, and outputs it as the load signal.

To the other two signal input terminals of the three-input AND gate 200, output of the signal detection part 195 and the code amount agreement signal are input. To the other two input terminals of the three-input AND gate 201, the output of the signal detection part 195 and the packet header generation finish signal are input. To the other two input terminals of the three-input AND gate 202, an inverted signal of the output of the signal detection part 195 and the code amount agreement signal are input.

In the above-described configuration, the clr signal is switched to the high level when the value of the CB2in signal is 0, 3, 6 or 18 and also the packet header generation signal and the packet header generation finish signal have the low levels, while it being switched to the low level according to signal change in the packet header generation signal and the code amount agreement signal.

The load signal is switched to the high level in response to the packet head generation finish signal being switched to the high level when the value of the CB2in signal is 0, 3, 6 or 18 and also the packet header generation signal has the high level, while it is switched to the low level when packet header generation signal or the packet header generation finish signal is switched to the low level.

(3) Image Compressing Apparatus According to Second Embodiment

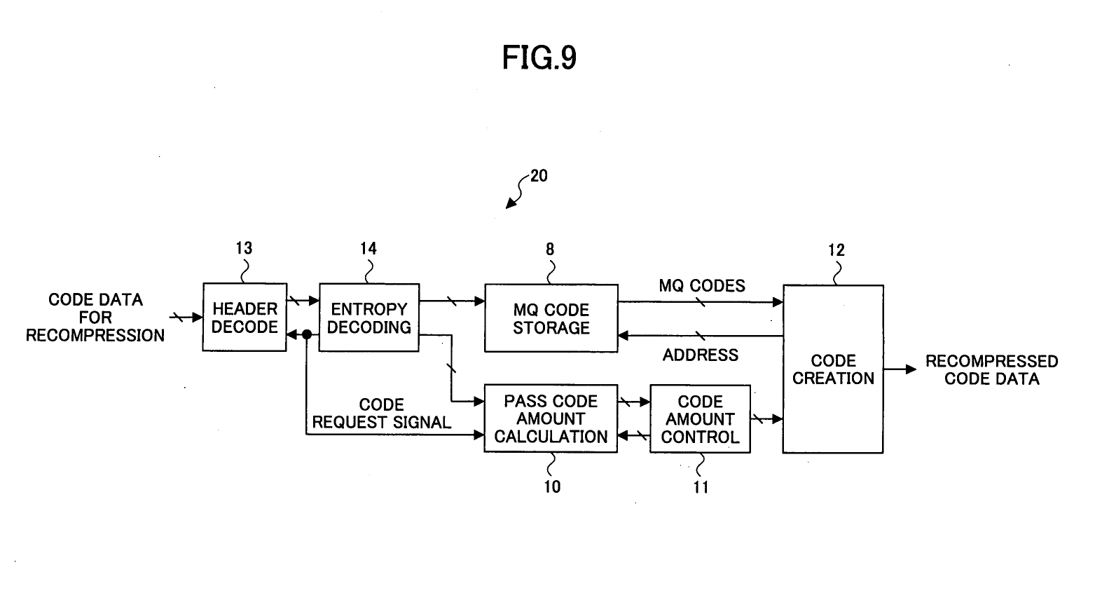

FIG. 9 shows a configuration of an image compressing apparatus 20 according to a second embodiment of the present invention. The image compressing apparatus 20 according to the second embodiment is configured from extracting only processing parts concerning the code data recompression from among the above-described image compressing apparatus 1 according to the first embodiment of the present invention. In FIG. 9, the same reference numerals are given to the same parts as those included in the image compressing apparatus 1.

In the image compressing apparatus 20, given code data is processed by a header decode part 13 and an entropy decoding part 14, and, after that, the same as in the image compressing apparatus 1, code information (the number of zero bit planes ZBP) and data of MQ codes are stored in an MQ code storage memory 8 for each code block. A pass code amount calculation part 10 obtains a total data amount of MQ codes for each code block, and a data amount of MQ codes for each coding pass. A code amount control part 11 obtains a data amount of MQ codes and the number of coding passes for each code block after compression. A code creation part 12 creates code data after the compression based on the above-mentioned data, and outputs the same.

A configuration and operation of each control part are same as those in the above-described image compressing part 1, and thus, further description is omitted.

Since the image compressing apparatus 20 configured as described above has only the function of code data recompression, it is possible to miniaturize the apparatus size.

Further, the present invention is not limited to the above-described embodiments, and variations and modifications may be made without departing from the basic concept of the present invention claimed.

The present application is based on Japanese Priority Applications Nos.2003-296093, filed on Aug. 20, 2003, the entire contents of which are hereby incorporated by reference.

1. An image compressing apparatus having code data input thereto, which code data comprises data of codes and additional information, said data of codes being created from compressing, for each processing unit at a predetermined first compression rate, coefficient data obtained from analyzing image data with respect to frequency, said additional information being data necessary for decoding the data of codes, comprising:
a memory storing at least the data of codes of the code data;
a code amount calculating part calculating, from the code data, a first total data amount of codes for each processing unit;
a code amount control part obtaining a second total data amount of codes for each processing unit from the first data amount of codes for each processing unit calculated by said code amount calculating part, which second data amount is a data amount obtained if image data obtained from decoding the code data is again compressed and coded at a predetermined second compression rate higher than said predetermined first compression rate; and
a code creation part creating recompressed code data by updating the additional information to information for the recompressed state, and reading out the data of codes for each processing unit from said memory for the second total data amount in a predetermined manner.

2. The image compressing apparatus as claimed in claim 1, wherein:
said predetermined manner of reading out the data of codes for each processing unit from said memory performed by said code creation part is to read in an order such that data of codes, which are those concerning more significant bit data of the coefficient data if they are decoded, are read out earlier.

3. The image compressing apparatus as claimed in claim 1, having the code data input thereto, which code data is obtained from coding according to JPEG2000, and comprises the data of codes and the additional information, said additional information comprising code information indicating the number of zero bit planes for each processing unit, and said data of codes comprising MQ codes, wherein:
said memory stores the code information and the data of MQ codes for each processing unit; and
said code amount control part obtains the second total data amount of MQ codes for each processing unit to be obtained if the image data obtained from decoding the code data is compressed at the second predetermined compression rate, from a total data amount of MQ codes for each processing unit obtained from performing entropy decoding processing according to JPEG2000 on the code data and a data amount of MQ codes for respective coding passes.

4. The image comprising apparatus as claimed in claim 3, comprising:
a coding part compressing and coding the image data according to JPEG2000 and creating the code data comprising the additional information and the data of MQ codes; and
a decoding part decoding the code data having a configuration comprising the additional data and the data of MQ codes, into image data.

5. An image compressing method having code data input thereto, which code data comprises data of codes and additional information, said data of codes being created from compressing, for each processing unit at a predetermined first compression rate, coefficient data obtained from analyzing image data with respect to frequency, said additional information being data necessary for decoding the data of codes, and creating code data obtained from compressing at a different compression rate, comprising the steps of:
a) storing at least the data of codes of the code data in a memory;
b) calculating, from the code data, a first total data amount of codes for each processing unit;
c) obtaining a second total data amount of codes for each processing unit from the first data amount of codes for each processing unit calculated in said step b), which second data amount is a data amount obtained if image data obtained from decoding the code data is again compressed and coded at a predetermined second compression rate higher than said predetermined first compression rate; and
d) creating recompressed code data by updating the additional information to information for the recompressed state, and reading out the data of codes for each processing unit from said memory for the second total data amount in a predetermined manner.
